(19) United States
(12) Patent Application Publication
(10) Pub. No.: US 2016/0239372 A1
(43) Pub. Date: Aug. 18, 2016

(54) UNDOING CHANGES MADE BY THREADS

(71) Applicant: HEWLETT PACKARD ENTERPRISE DEVELOPMENT LP, Houston, TX (US)

(72) Inventor: Dhruva Chakrabarti, Palo Alto, CA (US)

(21) Appl. No.: 15/023,853

(22) PCT Filed: Sep. 26, 2013
(86) PCT No.: PCT/US2013/061889

§ 371 Date: Mar. 22, 2016

(51) Int. Cl. G06F 11/07; G06F 9/50; G06F 9/52

(52) U.S. Cl. CPC G06F 11/0793; G06F 11/0721; G06F 11/0751; G06F 11/0778; G06F 9/52; G06F 9/5016

(57) ABSTRACT

Disclosed herein are a system, non-transitory computer readable medium, and method for recovering from an abnormal failure of a program. Changes made by a plurality of threads of the program are undone in a reverse order in which the changes were made.

### BACKGROUND

Software developers heretofore may use multithreading to increase a program's performance. Multithreading is a widespread programming technique that allows multiple sub-programs (“threads”) to spawn from the main program. These threads share the main program's resources, but are able to execute independently. The threaded programming model provides developers with a useful abstraction of concurrent execution.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, the threads spawning from a main program may share the main program's resources, but are able to execute independently. Each thread may also execute independently from other threads. Furthermore, a multithreaded program may share and alter the same memory locations. The memory locations may be encoded in the source code as variables. When a given thread alters a memory location shared with other threads, the given thread may lock the memory location. That is, the given thread may obtain exclusive access to the memory location to ensure that other threads do not intervene while it's modifying the memory location. The actions of each thread may be logged so that the log files may be used to undo the activities of each thread in the event of a failure. However, the sequence in which the operations are undone may be complex given that multiple threads may be changing the same memory location. Undoing the transactions of each thread separately without considering changes made by other threads in between may lead to changes being rolled back out of sequence. In this instance, the program and its shared memory locations may be left in an inconsistent state.

In view of the foregoing, disclosed herein are a system, non-transitory computer readable medium, and method for recovering from an abnormal failure of a program. In one example, changes made by a plurality of threads of the program may be undone in a reverse order in which the changes were made. In another example, changes to a given memory location made by a first thread of the computer program may be undone while the first thread had exclusive access to the given memory location. In another aspect, it may be determined whether the first thread released exclusive access to the given memory location and it may be determined whether a second thread of the computer program obtained exclusive access to the given memory location after release by the first thread. In yet a further example, changes to a given memory location made by the second thread of the program may be undone while the second thread had exclusive access to the given memory location, if the second thread obtained exclusive access to the given memory location after release by the first thread. In another aspect undo of changes to the given memory location by the first thread may be resumed, if the first thread retained exclusive access to the given memory location after release by the second thread. Thus, the system, non-transitory computer readable medium, and method disclosed herein may rollback changes made by threads of a program while ensuring that the changes are undone in a correct order. The aspects, features and advantages of the present disclosure will be appreciated when considered with reference to the following description of examples and accompanying figures. The following description does not limit the application; rather, the scope of the disclosure is defined by the appended claims and equivalents.

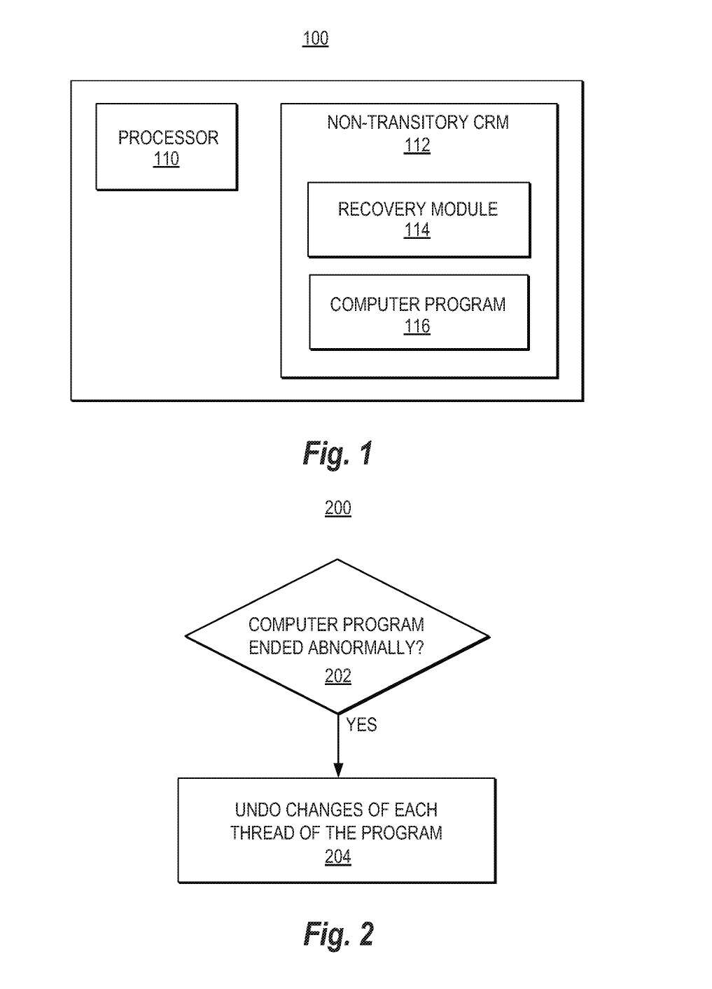

FIG. 1 presents a schematic diagram of an illustrative computer apparatus 100 depicting various components in accordance with aspects of the present disclosure. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network using conventional protocols (e.g., Ethernet, Wi-Fi, Bluetooth, etc.). The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include recovery module 114. Non-transitory CRM 112 may be used by or in connection with any instruction execution system that can fetch or obtain the logic from non-transitory CRM 112 and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, computer program 116 may instruct processor 110 to generate log entries that specify changes made to memory locations by a plurality of threads spawning from computer program 116. The log entries may further indicate when each thread obtained and released exclusive access to each memory location. In another example, recovery module 114 may determine whether the computer program has ended abnormally and may undo changes to the memory locations in a reverse order in which each thread changed a given memory location while each thread had exclusive access to the given memory location.

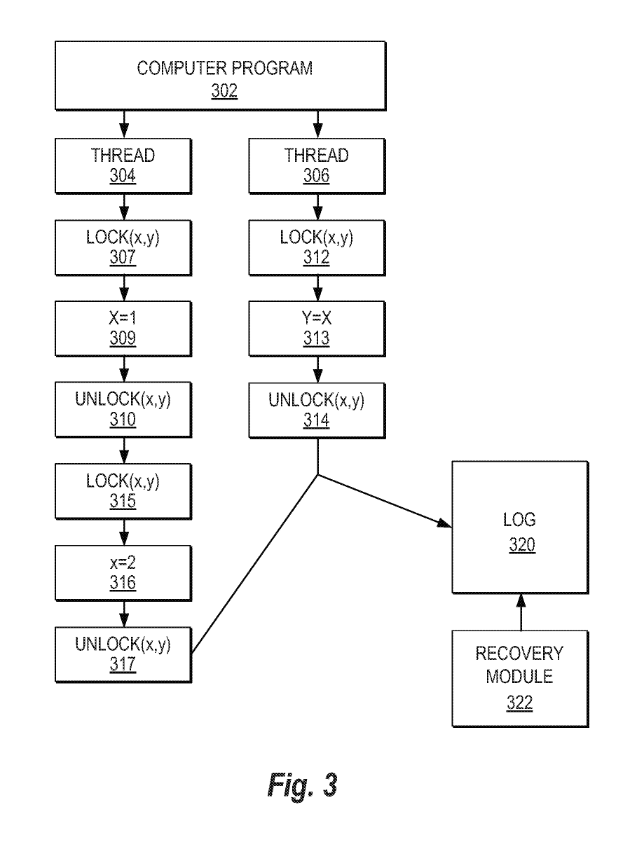

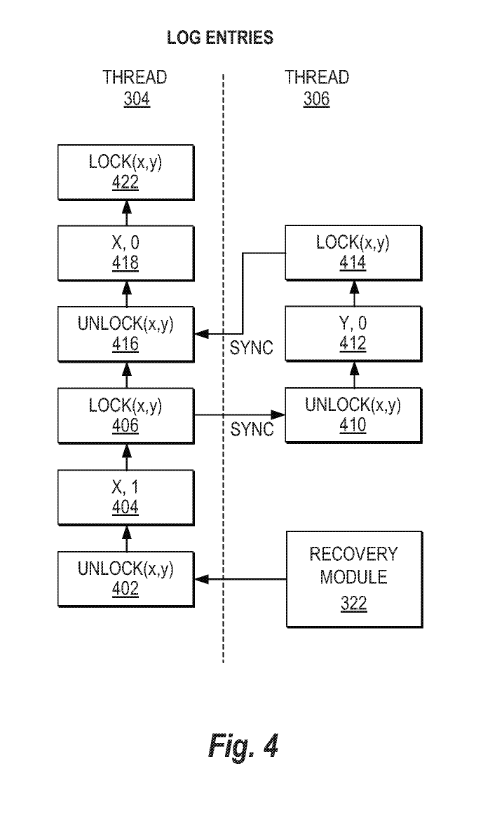

Working examples of the system, method, and non-transitory computer-readable medium are shown in FIGS. 2-4, In particular, FIG, 2 illustrates a flow diagram of an example method 200 for recovering from a program failure. FIGS. 3-4 each show a working example in accordance with the techniques disclosed herein. The actions shown in FIGS. 3-4 will be discussed below with regard to the flow diagram of FIG, 2.

Referring to FIG. 2, it may be determined whether a computer ended abnormally, as shown in block 202. Referring now to FIG, 3, a computer program 302 is shown executing two threads, thread 304 and thread 306. In this example, the threads write log entries in log 320. FIG. 3 depicts the example steps executed by each thread. In step 307, thread 304 obtains exclusive access (“lock”) to two memory locations represented by variables X and Y. In step 309, thread 304 changes the value of X to 1 and then unlocks variables X and Y in step 310. Then, thread 306 obtains a lock on variables X and Y in step 312 and assigns the value of X to Y in step 313. Thread 306 then unlocks variables X and Y in step 314. At step 315, thread 304 again obtains an exclusive lock on variable X and Y and changes the value of X to 2 in step 316. After thread 304 unlocks variables X and Y in step 317, computer program 302 may crash. When computer program 302 crashes, recovery module 322 may read the log entries in log 320 and begin rolling back changes to variables X and Y and attempt to return the variables to a consistent state,

Referring back to FIG. 2, changes made by the threads of the program may be undone in a reverse order in which the plurality of threads changed the memory locations, as shown in block 204. Referring now to FIG. 4, recovery module 322 is shown undoing the changes made by computer program 302 in FIG. 3. Recovery module 322 may read the example log entries shown in FIG. 4 in a reverse order and may undo the changes based on an analysis of the log entries. The log entries shown in FIG. 4 may capture intra-thread dependences in reverse execution order. For example, an edge from change log entry 418 to lock log entry 422 is added since thread 304 executed the change operation indicated by log entry 418 immediately after acquiring the lock indicated by log entry 422. Inter-thread SYNC edges between log entry 406 to 410 and 414 to 416 capture inter-thread dependences that arise when one thread synchronizes with another. In one example, a second thread may synchronize with a first thread when the first thread releases a lock that the second thread subsequently acquires. Log entry 402 specifies that a first thread released exclusive access to variables X and Y. In one example, when recovery module 322 encounters an unlock log record, it may determine if a second thread obtained exclusive access to the same variables or memory locations that were unlocked. In this example, there is no indication that a second thread obtained a lock on variables X and Y after log entry 402 was recorded. That is, there is no log entry indicating that another thread obtained a lock on variables X and Y. Therefore, after reading log entry 402, recovery module 322 may move on to log entry 404. In another example, whenever a thread changes a variable or memory location, the log entry associated with the change (i.e., the change log entry) may indicate the following: the memory location or the variable that was changed and the old value of the variable before the change.

In the example of FIG. 4, log entry 404 corresponds to step 316 in FIG. 3. Log entry 404 indicates that variable X had a value of 1 before it was changed to 2. Thus, recovery module 322 may undo the change made in step 316 of FIG. 3 by changing variable X back to 1. Log entry 406 indicates that variables X and Y were previously locked. In one aspect, recovery module 322 may ignore any log entry that indicates a lock. Log entry 416 indicates another unlock of variables X and Y. As noted above, recovery module 322 may check whether a second thread obtained a lock on the variables, when it encounters an unlock log entry. Here, a second thread does obtain a lock on variables X and Y after log entry 416 was recorded, as indicated by log entry 414. At this point, if the program crashes because of a hardware or software failure, the recovery module 322 may begin to undo some of the changes made by the threads. Log entry 412 corresponds to step 313 of FIG. 3. Thus, in this example, recovery module 322 may rollback the execution of step 313 in FIG. 3 using the corresponding log entry 412. Log entry 412 shows that the value of Y before step 313 was 0; accordingly, recovery module 322 may assign 0 back to variable Y. Log entry 410 indicates that that the variables were unlocked again and recovery module may determine whether any other thread obtained a lock on the variables. Here, thread 304 did retain a lock on the variables as indicated by log entry 422. Recovery module 322 may then read log entry 418, which corresponds to step 309 in FIG. 3. Log entry 418 may cause recovery module 322 to roll the value of X back to 0.

As noted above, the instructions for carrying out the foregoing techniques may comprise any set of instructions to be executed directly or indirectly by at least one processor. In one aspect, given a log entry e, a function prev(e) may return the log entry that was generated before log entry e. For example, applying prev(e) to log entry 402 in FIG. 4 may return log entry 404. In a further aspect, given an unlock log entry e generated by a first thread, a function hb_prev(e), may return a lock log entry generated by a second thread right after the unlock log entry e was generated. For example, applying hb_prev(e) to log entry 416 in FIG. 4 may return log entry 414. In yet a further aspect, a function last_log(t) may return the next log entry of activity that has yet to be rolled back for a given thread t. The following example pseudocode is one illustrative way to utilize the aforementioned example functions:

main( ) {

for every thread tid

last_log(tid) = last log created by tid

for every thread tid

Recover(tid)

}
Recover(tid) {
log_entry = last_log(tid)

while (log_entry) {

```
  if log type is lock, mark it visited
  else if type is change, apply the undo operation
  else if type is unlock {
```

acq_entry = hb_prev(log_entry)
if (acq_entry is present and acq_entry not already visited)
{

last_log(tid) = prev(log_entry)
new_tid = thread id of acq_entry
Recover(new_tid)

}

```
    }
    log_entry = prev(log_entry)
```

}

}

The example pseudocode above is one way to implement the working examples shown in FIGS. 3-4. The pseudocode above starts at an arbitrary thread; obtains its last log entry using the last_log()function; and, begins rolling back the activity expressed in the log entries in reverse order. If a lock log entry is encountered, the lock log entry may be marked as visited but no action may be taken. If a change log entry is encountered, the appropriate undo action may be taken (e.g., writing the previous value indicated in the log entry back to the memory location). If an unlock log entry is encountered, it may be determined whether a second thread acquired a lock on the same variables or memory locations using the hb_prev()function; If so, a switch may be made to the logs of this second thread and the last log of the second thread that has yet to be rolled back may be obtained using the last_log()function; the rollback may begin with the logs created by that second thread. The pseudocode may loop through the log entries until all activities are undone. The last_logo() entry of a given thread may be tracked and maintained as the pseudocode alternates between threads.

Advantageously, the foregoing computer apparatus, non-transitory computer readable medium, and method ensure that multithreaded programs are returned to a consistent state after a failure. In this regard, changes to a given variable or memory location may be undone in a reverse order in which each thread made the change. A recovery module may alternate between prerecorded log records generated by the threads, when it determines that exclusive access to a memory location has changed to another thread. In turn, users may be rest assured that their systems will be returned to a consistent state in the event of a failure.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently and steps may be added or omitted.

1. A system comprising:
a computer program which upon execution generates log entries that specify changes made to memory locations by a plurality of threads spawning from the computer program, the log entries further to indicate when each thread obtained and released exclusive access to each memory location;
a recovery module which upon execution instructs at least one processor to:
determine whether the computer program has ended abnormally; and
undo changes to the memory locations in a reverse order in which the threads changed the memory locations while each thread had exclusive access to a given memory location.

2. The system of claim 1, wherein the recovery module upon execution further instructs at least one processor to undo changes to the given memory location made by a first thread of the computer program while the first thread had exclusive access to the given memory location.

3. The system of claim 2, wherein the recovery module upon execution further instructs at least one processor to:
determine whether the first thread released exclusive access to the given memory location; and
determine whether a second thread of the computer program obtained exclusive access to the given memory location after release by the first thread.

4. The system of claim 3, wherein the recovery module upon execution further instructs at least one processor to undo changes to the given memory location made by the second thread of the program while the second thread had exclusive access to the given memory location, if the second thread obtained exclusive access to the given memory location after release by the first thread.

5. The system of claim 4, wherein the recovery module upon execution further instructs at least one processor to resume undo of changes to the given memory location by the first thread, if the first thread retained exclusive access to the given memory location after release by the second thread.

6. A non-transitory computer readable medium having instructions therein which, if executed, cause at least one processor to:
determine whether a computer program has ended abnormally;
analyze prerecorded log records that specify changes made to memory locations by a plurality of threads spawning from the computer program and which specify when each thread had exclusive access to each memory location; and
undo changes to the memory locations in accordance with an analysis of the log records such that the changes are undone in a reverse order in which the plurality of threads changed the memory locations.

7. The non-transitory computer readable medium of claim 6, wherein the instructions therein upon execution further instructs at least one processor to undo changes to a given memory location made by a first thread of a program while the first thread had exclusive access to the given memory location.

8. The non-transitory computer readable medium of claim 7, wherein the instructions therein upon execution further instructs at least one processor to:
determine whether the first thread released exclusive access to the given memory location; and
determine whether a second thread of the program obtained exclusive access to the given memory location after release by the first thread.

9. The non-transitory computer readable medium of claim 8, wherein the instructions therein upon execution further instructs at least one processor to undo changes to the given memory location made by the second thread of the program while the second thread had exclusive access to the memory location, if the second thread obtained exclusive access to the given memory location after release by the first thread.

10. The non-transitory computer readable medium of claim 9, wherein the instructions therein upon execution further instructs at least one processor to resume undo of changes to the given memory location by the first thread, if the first thread retained exclusive access to the given memory location after release by the second thread.

11. A method comprising
determining, using at least one processor, whether a computer program has ended abnormally;
analyzing, using at least one processor, log files generated by a plurality of threads that spawned from the computer program, the log files specifying changes made to variables by each thread and when each thread had exclusive access to each variable; and
undoing, using at least one processor, changes to the variables such that the changes are undone in a reverse order in which the plurality of threads changed the variables while each thread had exclusive access to a variable.

12. The method of claim 11, further comprising undoing, using at least one processor, changes to the variable made by a first thread of a program while the first thread had exclusive access to the variable.

13. The method of claim 12, further comprising:
determining, using at least one processor, whether the first thread released exclusive access to the variable; and
determining, using at least one processor, whether a second thread of the program obtained exclusive access to the variable after release by the first thread.

14. The method of claim 13, further comprising undoing, using at least one processor, changes to the variable made by the second thread of the program while the second thread had exclusive access to the variable, if the second thread obtained exclusive access to the variable after release by the first thread.

15. The method of claim 14, further comprising resuming, using at least one processor, to undo changes to the variable by the first thread, if the first thread retained exclusive access to the variable after release by the second thread.
